(19) United States
(12) Patent Application Publication
(10) Pub. No.: US 2012/0025526 A1
(43) Pub. Date: Feb. 2, 2012

(54) SYSTEM AND METHOD FOR MONITORING WIND TURBINE GEARBOX HEALTH AND PERFORMANCE

(75) Inventors: HUAGENG LUO, CLIFTON PARK, NY (US); DARREN LEE HALLMAN, SCOTIA, NY (US); ROBERT ARVIN HEDEEN, CLIFTON PARK, NY (US); MICHAEL SIRAK, ERIE, PA (US); DENNIS RICHTER, LAWRENCE PARK, PA (US)

(73) Assignee: GENERAL ELECTRIC COMPANY, SCHENECTADY, NY (US)

(21) Appl. No.: 12/847,209

(22) Filed: Jul. 30, 2010

(51) Int. Cl. H02P 9/04; G06F 19/00

(52) U.S. Cl. 290/44; 702/34

(57) ABSTRACT

A system and method are provided to monitor the health and performance of a wind turbine gearbox. A plurality of sensors coupled to the wind turbine gearbox provide input to a controller. The controller generates output information that includes performance and health information of the wind turbine gearbox based on the input received from each of the sensors.

### BACKGROUND OF THE INVENTION

Wind power is one of the fastest growing energy sources around the world. The long-term economic competitiveness of wind power as compared to other energy production technologies is closely related to the reliability and maintenance costs associated with the wind turbine. The wind turbine gearbox is generally the most expensive component to purchase, maintain, and repair.

The conventional vibration monitoring system is based on features uniquely associated with the gearbox bearing design, the gearbox gear design, and the gearbox shaft rotational speeds. For example, a speed of a main rotor is amplified to orders of magnitude by a multi-stage gearbox. Thus, the gear and bearing vibration signatures are high magnitude orders of the main shaft rotational frequency. Moreover, in operation, the main shaft speed is not precisely controlled. Therefore, the rotational speed of the main shaft varies based on the wind conditions and the generator loading. A small variation in the main shaft speed may cause significant variations in the bearing and gear vibration feature frequencies, especially those associated with the high-speed shaft. As a result, the conventional vibration monitoring system may be less effective in providing reliable information under all operating conditions.

### BRIEF DESCRIPTION OF THE INVENTION

A system and method are provided to monitor the health and performance of a wind turbine gearbox. A plurality of sensors coupled to the wind turbine gearbox provide input to a controller. The controller generates output information that includes performance and health information of the wind turbine gearbox based on the input received from each of the sensors.

### BRIEF DESCRIPTION OF THE DRAWINGS

FIG. 1 is a pictorial view of an exemplary configuration of a wind turbine in accordance with various embodiments.

FIG. 2 is a cut-away perspective view of the nacelle of the exemplary wind turbine configuration shown in FIG. 1.

FIG. 3 is a simplified schematic illustration of an exemplary system that may be utilized with the wind turbine shown in FIGS. 1 and 2 in accordance with various embodiments.

FIG. 4 is a graphical illustration of exemplary information that may be generated using the system shown in FIG. 3 in accordance with various embodiments.

FIG. 5 is a graphical illustration of exemplary information that may be generated using the system shown in FIG. 3 in accordance with various embodiments.

FIG. 6 is a graphical illustration of exemplary information that may be generated using the system shown in FIG. 3 in accordance with various embodiments.

FIG. 7 is a graphical illustration of exemplary information that may be generated using the system shown in FIG. 3 in accordance with various embodiments.

FIG. 8 is a graphical illustration of exemplary information that may be generated using the system shown in FIG. 3 in accordance with various embodiments.

FIG. 9 is a graphical illustration of exemplary information that may be generated using the system shown in FIG. 3 in accordance with various embodiments.

FIG. 10 is a graphical illustration of exemplary information that may be generated using the system shown in FIG. 3 in accordance with various embodiments.

FIG. 11 is a graphical illustration of exemplary information that may be generated using the system shown in FIG. 3 in accordance with various embodiments.

### DETAILED DESCRIPTION OF THE INVENTION

Embodiments of the invention will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors, controllers or memories) may be implemented in a single piece of hardware (e.g., a general purpose signal processor or random access memory, hard disk, or the like) or multiple pieces of hardware. Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Various embodiments described herein provide a health and performance monitoring system and method that may be utilized to monitor the health and performance of a wind turbine gearbox. By practicing at least one embodiment, the health and performance monitoring system and method enable personnel to monitor the health of the wind turbine gearbox. Specifically the health and performance monitoring system acquires health information that enables an operator to identify potential or current damage of a variety of components installed in the wind turbine gearbox. Embodiments of the system and method also enable an operator to identify the extent of the damage and to modify the operation of the wind turbine gearbox to extend the operational life of the wind turbine gearbox until repairs may be accomplished. Additionally, embodiments of the system and method enable the operator to ascertain the progression of damage to a component within the wind turbine gearbox and modify the operation of the wind turbine gearbox to based on the extent of the damage.

Embodiments of the health and performance monitoring system and method also acquire performance information from the wind turbine gearbox. The performance information may be transmitted to, and utilized by, remote personnel to monitor the current operational performance of the wind turbine gearbox. The performance information acquired from the gearbox may be compared to design performance information to enable designers to evaluate the operational performance of the wind turbine. Based on the evaluation, the designers may install upgrades to the wind turbine gearbox to improve or optimize the performance of the wind turbine gearbox. Embodiments of the health and monitoring system and method may also be configured to automatically adjust the operation of the wind turbine based on the health and performance information. For example, in some embodiments, the health and performance monitoring system may automatically stop or shut-down the operation of the wind turbine when the health or performance information indicates that a component within the gearbox is damaged or may have potential damage.

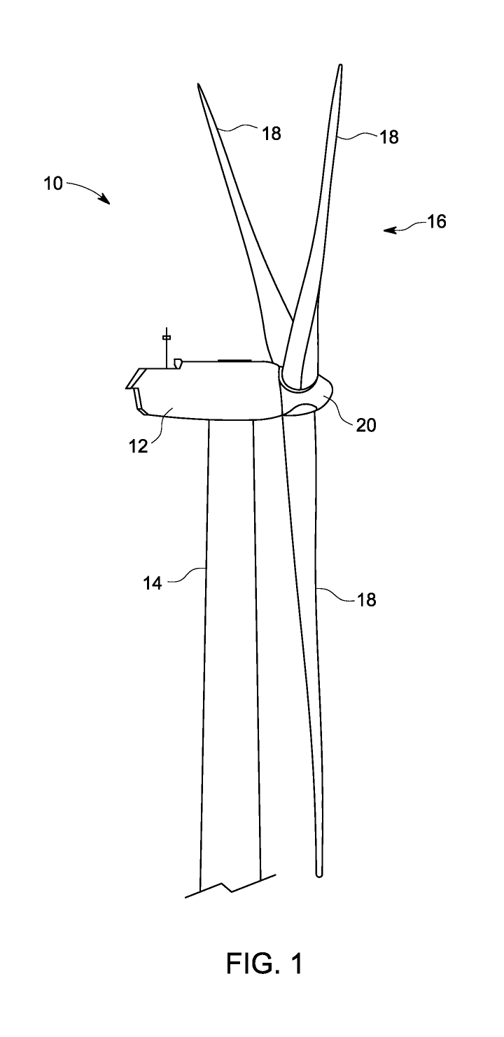

FIG. 1 is a pictorial view of an exemplary configuration of a wind turbine 10 in accordance with various embodiments. The wind turbine 10 includes a nacelle 12 housing a generator. The nacelle 12 is mounted atop a tower 14, only a portion of which is shown in FIG. 1. The height of the tower 14 is selected based upon various factors and conditions to optimize the operational performance of the wind turbine 10. The wind turbine 10 also includes a rotor 16 that includes a plurality of rotor blades 18 that are attached to a rotating hub 20. Although the wind turbine 10 illustrated in FIG. 1 is shown as including three rotor blades 18, it should be realized that the wind turbine 10 may include more than three rotor blades 18 and there are no specific limits on the number of rotor blades 18 that may be installed on the wind turbine 10.

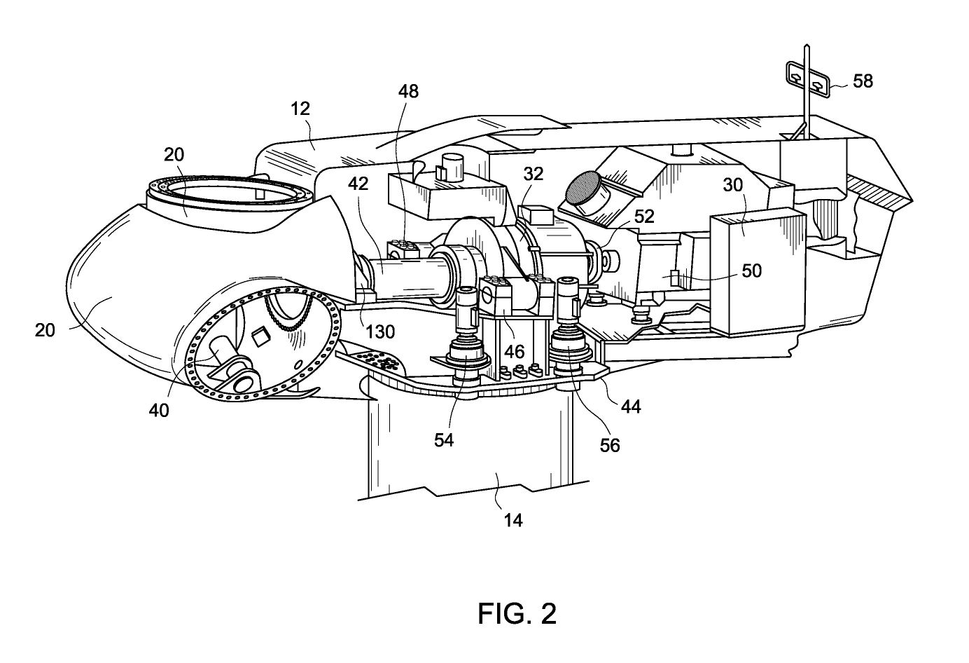

FIG. 2 is a cut-away perspective view of the nacelle 12 shown in FIG. 1. In the exemplary embodiment, the nacelle 12 includes a controller 30 that is configured to perform health and performance monitoring of a gearbox 32 installed in the nacelle 12. In some embodiments, the controller 30 may also be configured to perform overall system monitoring and control, including pitch and speed regulation, high-speed shaft and yaw brake application, yaw and pump motor application and fault monitoring.

For example, the controller may provide control signals to a variable blade pitch drive unit 40 to control the pitch of the rotor blades 18 (shown in FIG. 1) that drive the rotating hub 20 as a result of wind. In some embodiments, the pitch of the rotor blades 18 are individually controlled using the blade pitch drive unit 40. The drive train of the wind turbine 10 includes a main rotor shaft 42, also referred to as a “low speed shaft”. The main rotor shaft 42 is connected to the rotating hub 20 and the gearbox 32 to drive a high speed shaft enclosed within the gearbox 32. The configuration of the gearbox 32 is discussed in more detail below. The gearbox 32, in some embodiments, is secured to a stationary frame 44 utilizing a pair of torque arms 46 and 48. In operation, the rotation of the rotating hub 20 causes a torque to occur on the main rotor shaft 42 causing the main rotor shaft 42 to rotate. Torque is a pseudo-vector corresponding to the tendency of a force to rotate an object about some axis, e.g. to rotate the main rotor shaft 42 around a central rotational axis. The pair of torque arms 46 and 48 facilitate connecting the center of the rotational axis of the main rotor shaft 42 to a point where the force is applied, in this example, to the stationary frame 44. Accordingly, rotor torque is transmitted via the main rotor shaft 42 to the gearbox 32. The torque is then transmitted from the gearbox 32 to a generator 50, via a coupling 52. The generator 50 may be of any suitable type, for example, a wound rotor induction generator.

A yaw drive 54 and a yaw deck 56 provide a yaw orientation system for the wind turbine 10. In some embodiments, the yaw orientation system is electrically operated and controlled by the controller utilizing information received from various sensors installed on the wind turbine 10. The wind turbine 10 may also include a wind vane 58 as a back-up or a redundant system for providing information for the yaw orientation system.

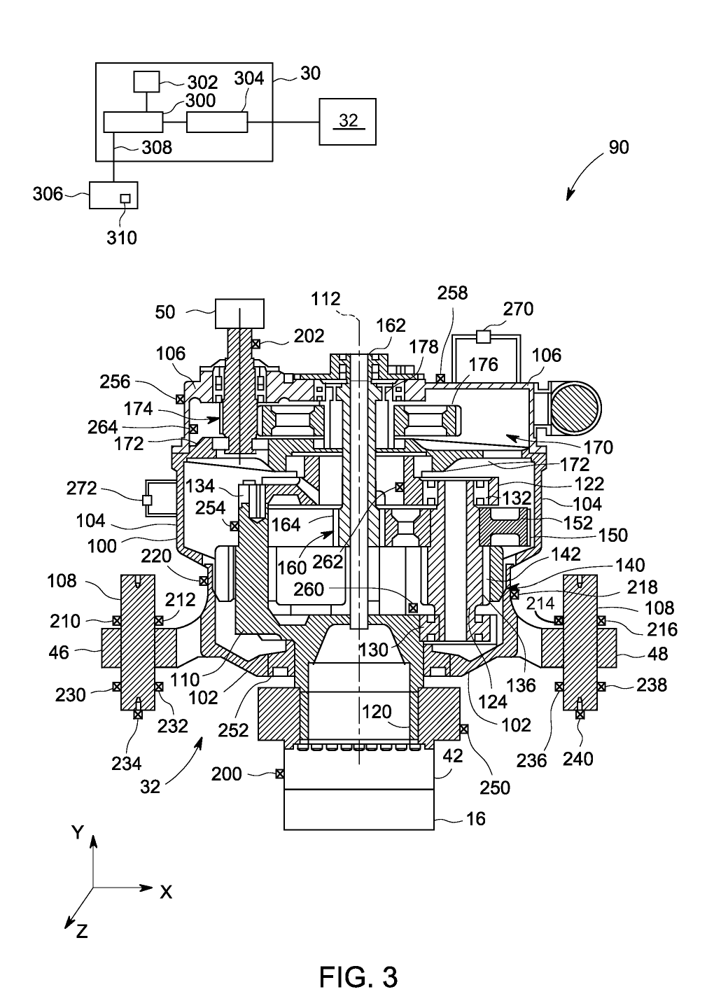

FIG. 3 is a simplified schematic illustration of an exemplary system 90 that may be utilized to perform wind turbine gearbox health condition monitoring and performance assessment of an exemplary wind turbine gearbox, such as gearbox 32 shown in FIG. 2. In the exemplary embodiment, a cross-sectional view of the gearbox 32 is shown in FIG. 3. In the exemplary embodiment, the system 90 is coupled to the exemplary wind turbine gearbox 32. As discussed above, the gearbox 32 is preferably coupled between the rotor 16 and the generator 50. During operation, wind causes the rotor 16 to rotate. The rotational force of the rotor 16 is transmitted, via the gearbox 32, to the generator 50, which includes a generator rotor (not shown). The generator rotor typically operates at a rotational speed that is greater than a rotational speed of the rotor 16. Thus, during normal operation, the gearbox 32 is configured to increase the speed of rotation produced by the rotor 16 to the more desirable speed for driving the rotor of the generator 50.

In the exemplary embodiment, the gearbox 32 includes a gearbox housing 100, which includes an input end cover 102, a planet gear cover 104, and a final stage cover 106. The gearbox housing 100 is supported on the nacelle 12 by a pair of support pins 108. The input end cover 102 of the gearbox housing 100 extends around and supports a planet carrier 110, for rotation of the planet carrier 110 relative to the housing 100 about a central axis 112 of the planet carrier 110. An input hub 120 on a first end of the planet carrier 110 is coupled to the main rotor shaft 42, in a suitable manner, not shown, for rotation with the rotor 16. The input hub 120 receives rotational force from the rotor 16 and rotates the planet carrier 110 relative to the gearbox housing 100 in response to that rotational force. The second end of the planet carrier 110, as illustrated, is substantially open, with a detachably mounted end plate 122 attached to the second end of the planet carrier 110. This removable carrier end plate 122 acts as a planet bearing support, as explained below.

The planet carrier 110 supports a plurality of planet pinions 124 therein for orbital movement about the central axis 112. In the illustrated embodiment, three planet pinions 124 are provided, spaced apart equally about the central axis 112. Bearings support the planet pinions 124 for rotation relative to the planet carrier 110. Specifically, a first planet bearing 130, mounted at the first end of the planet carrier 110, engages and supports a first end of each planet pinion 124, supporting that end of the planet pinion 124 directly from the planet carrier 110. A second planet hearing 132, which is mounted on a planet carrier end plate 134 engages and supports a second end of each planet pinion 124, thereby supporting the second end of the planet pinion 124 indirectly from the planet carrier 110. Each one of the planet pinions 124 has a plurality of external gear teeth 136 which, in the illustrated embodiment, are spur gear teeth.

The gearbox 32 also includes a ring gear 140. The ring gear 140 is substantially fixed relative to the interior of the gearbox housing 100. That is, the ring gear 140 has external splines that mate with splines on the interior of the housing 100, preventing the ring gear 140 from rotating relative to the housing 100. The ring gear 140 basically floats relative to the housing 100, in that the ring gear 140 can move radially a slight amount, within the clearance between the external splines on the ring gear 140 and the internal splines on the housing 100. The planet pinions 124 are substantially smaller in diameter than the ring gear 140.

The ring gear 140 has an array of internal spur or helical gear teeth 142. The internal gear teeth 142 on the ring gear 140 are in meshing engagement with the external gear teeth 136 on the planet pinions 124. As a result, orbital movement of the planet pinions 124 about the central axis 112, in response to rotation of the input hub 120 and the planet carrier 110 about the central axis 112, causes the planet pinions 124 to rotate about their own axes relative to the planet carrier 110. The rotational force transmitted from the rotor 16 to the input hub 120 is thus transmitted entirely to the planet pinions 124 to drive the planet pinions 124 to rotate about their own axes.

The gearbox 32 also includes a plurality of planet gears 150. The number of planet gears 150 is equal to the number of planet pinions 124. In the illustrated embodiment, therefore, three planet gears 150 are provided. Each of the planet gears 150 is fixed to one of the planet pinions 124 for rotation with its associated planet pinion 124. Thus, in this exemplary embodiment, the gearbox 32 is a “compound” planetary gearbox. When the input hub 120 and the planet carrier 110 rotate, therefore, the rotational force of the input hub 120 is entirely transmitted through the planet pinions 124 to the planet gears 150 to drive the planet gears to rotate about the planet pinion axes.

The planet gears 150 are substantially larger in diameter than the planet pinions 124. Each one of the planet gears 150 has a plurality of external gear teeth 152 which, in the illustrated embodiment, are spur gear teeth. The gearbox 32 also includes a single sun gear 160 mounted within the planet carrier 110, surrounded by the planet pinions 124. The sun gear 160 is radially supported by contact with the surrounding planet gears 150, for rotation of the sun gear 160 relative to the gear box housing 100 about the central axis 112. The sun gear 160 has a hollow bore along its axis, and along the axis of its shaft extension. A hollow tube 162, fixed to the final stage cover 106 on the gearbox housing 100, passes through the bore of the sun gear 160 and its shaft extension, substantially along the axis 112, to conduct control wiring (not shown) through the gear box 32 to the rotor 16. The sun gear 160 rotates relative to, but does not contact, the hollow tube 162. The sun gear 160 is substantially smaller in diameter than the planet gears 150.

The sun gear 160 has a plurality of external spur or helical gear teeth 164 that are in meshing engagement with the external gear teeth 152 on the planet gears 150. As a result, rotation of the planet gears 150 about their axes, in response to rotation of the input hub 120 and the planet pinions 124, causes the sun gear 160 to rotate about the central axis 112. The rotational force of the input hub 120 and the planet carrier 110 is thus entirely transmitted through the planet gears 150 to the sun gear 160, driving the sun gear 160 for rotation about the central axis 112.

The gearbox 32 also includes a final stage 170, including a final stage end plate 172, the final stage cover 106, an output pinion 174, and an optional final stage gear 176. The output pinion 174 may also be referred to herein as the high-speed shaft 174. The final stage gear 176 is rotated with the sun gear 160, about the central axis 112, by a splined connection 178 at the end of the shaft extension of the sun gear 160. The splined end of the shaft extension of the sun gear 160 floats within the clearance in this splined connection to the final stage gear 176. Rotation of the high-speed shaft 174 drives the generator 50 thereby producing electrical energy. The final stage 170 is optional, and many gearboxes use the sun gear 160 as an input to the generator 50.

Input torque from the rotor 16 and the input hub 120 is split among the three planet pinions 124 and thus among the three planet gears 150, for transmission to the sun gear 160. This configuration spreads the high torque provided by the rotating input hub 120 among the planets. However, the sun gear 160 is the one point in the gear train in which all the torque is concentrated.

As shown in FIG. 3, the system 90 also includes various sensing devices that are coupled to the gearbox 32. The sensing devices are configured to collect various information that is related to the health and performance of the gearbox 32. The information collected from the sensors enables personnel to monitor both the health and performance of the gearbox 32 and implement corrective repairs or upgrades based on the information.

The sensing devices may include for example, a first tachometer 200 that is installed proximate to the main rotor shaft 42. In operation, the first tachometer 200 is configured to generate a signal that represents the rotational speed of the rotor shaft 42. The system 90 may include a second tachometer 202 that is installed proximate to the high-speed shaft 174. In operation, the second tachometer 202 is configured to generate a signal that represents the rotational speed of the high-speed shaft 174 and also the rotational speed of the generator 50.

The system 90 may further include at least one strain gauge that is coupled to the gearbox 32. In the exemplary embodiment, referring again to FIG. 3, the system 90 includes a plurality of strain gauges such as a first strain gauge 210 and a second strain gauge 212 that are each mounted proximate to the torque arm 46. The system 90 may also include a third strain gauge 214 and a fourth strain gauge 216 that are each mounted proximate to the torque arm 48. The strain gauges 210, 212, 214 and 216 provide strain information that represents the torque occurring at each respective torque arm 46 and 48. The torque information may be utilized by an operator or designer to monitor the performance of the wind turbine and/or to initiate design improvements to the wind turbine 10 based on the torque information. For example, the torque information may be compared to predetermined or design torque information to determine whether the actual torque seen at the torque arms 46 and 48 are within operational guidelines. If the torque is not within operational guidelines, a designer may utilize the torque information and information from other sensors described herein to modify the design of the wind turbine 10 or the gearbox 32.

The system 90 may further include at least one strain gauge that is configured to provide strain information on at least one component installed within the gearbox 32. For example, the system 90 may include a strain gauge 218 and a strain gauge 220 that are each coupled to the ring gear 140. It should be realized that the locations of the strain gauges 218 and 220 are only exemplary, and that other strain gauges may be installed on other gears within the gearbox 32.

The system 90 may further include at least one proximity probe that is configured to provide motion information that represents the motion of various components within the gearbox 32. For example, the system 90 may include a proximity probe 230, a proximity probe 232, and a proximity probe 234 that are each located proximate to the torque arm 46. Moreover, the system 90 may include a proximity probe 236, a proximity probe 238, and a proximity probe 240 that are each located proximate to the torque arm 48. In operation, the proximity probes 230, 232, and 234 measure the motion of the torque arm 46 in an X-direction, a Y-direction, and a Z-direction. Additionally, the proximity probes 236, 238, and 240 measure the motion of the torque arm 48 in an X-direction, a Y-direction, and a Z-direction. The combination of the proximity probes 230, 232, 234, 236, 238, and 240 provides motion information that enables an operator or designer to determine the quantity of motion seen at the torque arms 46 and 48, and thus the amount of motion of the gearbox 32. The motion information may be compared to predetermined or design motion information to determine whether the actual motion seen at the torque arms 46 and 48 are within operational guidelines. If the motion is not within operational guidelines, a designer may utilize the motion information and information from other sensors described herein to modify the design of the wind turbine 10 or the gearbox 32.

The system 90 may further include at least one accelerometer that is configured to provide information that represents the acceleration of various components in the gearbox 32. The accelerometers may also provide information that indicates vibration, inclination, dynamic distance, or the speed of the various components within the gearbox. For example, the system 90 may include an accelerometer 250 that is mounted proximate to a main shaft bearing 252. In operation, the accelerometer 250 may measure the speed or the vibrational characteristics of the main shaft bearing 252. The system 90 may also include an accelerometer 254 that is mounted proximate to the ring gear 140. The accelerometer 254 is configured to monitor the meshing between the ring gear 140 and the sun gear 160. The system 90 may further include an accelerometer 256 that is mounted proximate to the a high-speed shaft 174, and an accelerometer 258 that is mounted proximate to the final stage gear 176.

The information from the accelerometers 250, 254, 256 and 258 may be utilized to evaluate the operational performance of the gearbox 32 and the vibrational characteristics of the various meshing components and various bearings within the gearbox 32. The combination of the accelerometers 250, 252, 254 and 256 provides vibration information that enables an operator or designer to monitor health of the gearbox 32 by monitoring the quantity of vibration seen at the various locations within the gearbox 32. The vibration information also enables a designer to initiate design improvements to the wind turbine 10 based on the vibration information. Additionally, the vibration information may utilized to determine the performance of the gearbox 32 by comparing the vibration information to predetermined or design vibration information to determine whether the actual vibration is within operational guidelines. If the vibration is not within operational guidelines, a designer may utilize the vibration information and information from other sensors described herein to modify the design of the wind turbine 10 or the gearbox 32.

The system 90 may further include at least one temperature sensor. In the exemplary embodiment, the system 90 includes a temperature sensor 260 that is mounted proximate to the bearing 130 and a temperature sensor 262 that is mounted proximate to the bearing 132. It should be realized that although the exemplary embodiment illustrates temperature sensors 260 and 262, the system 90 may include other temperature sensors (not shown) that may be coupled proximate to other bearings within the gearbox 32. In the exemplary embodiment, the temperature sensors 260 and 262 provide information that represents the temperature of the various bearings associated with each respective temperature sensor. The system 90 may further include a temperature sensor 264 that monitors the internal temperature of the gearbox 32.

The information from the temperature sensors 260, 262, and 264 provides temperature information that enables an operator or designer to determine the temperature of each respective bearing within the gearbox 32, and to enable an operator to monitor the performance of the wind turbine and/or to also enable a designer to initiate design improvements to the wind turbine 10 based on the temperature information. Specifically, the temperature information may utilized to determine the performance of the gearbox 32 by comparing the temperature information to predetermined or design temperature information to determine whether the actual temperatures are within operational guidelines. If a temperature is not within operational guidelines, a designer may utilize the temperature information and information from other sensors described herein to modify the design of the wind turbine 10 or the gearbox 32.

The system 90 may also include a plurality of oil particle counters 270 and 272. The oil particle counters 270 and 272 are configured to identify various contaminants, such as for example, liquid contaminants or metallic particles that may be contaminating the lubricating oil supplying the gearbox 32 or oil within a respective bearing. It should be realized that although the exemplary embodiment illustrates two oil particle counters 270 and 272, the system 90 may include additional oil particle counters (not shown) that may be coupled proximate to other bearings. In operation, the information from the oil particle counters 270 and 272 may be integrated to cover all gearbox monitoring conditions.

The information from the oil particle counter 270 provides information that enables an operator or designer to identify potential bearing wear and the extent of the bearing wear, e.g. by identifying metallic particles within the oil, for at least some of the bearings installed in the gearbox 32. The oil particle counter 270 enables an operator to monitor the performance of the wind turbine and/or also enable a designer to initiate design improvements to the wind turbine 10 based on the coil particle content. Additionally, the oil particle counter information may utilized to determine the health of the gearbox 32 by comparing the oil particle counter information to predetermined or design oil particle counter information to determine whether the actual oil particle counter information is within operational guidelines. If information received from an oil particle counter is not within operational guidelines, a designer may utilize the oil particle counter information and information from other sensors described herein to modify the design of the wind turbine 10 or the gearbox 32.

In the exemplary embodiment, the outputs from the various sensors described herein are coupled to the controller 30. The controller 30 forms a portion of the exemplary wind turbine gearbox health condition monitoring and performance assessment system 90. The controller 30 includes a computer 300. As used herein, the term “computer” may include any processor or processor-based system including systems using controllers, reduced instruction set circuits (RISC), application specific integrated circuits (ASICs), logic circuits, and any other circuit or processor capable of executing the functions described herein. The above examples are exemplary only, and are thus not intended to limit in any way the definition and/or meaning of the term “computer”. During operation, the computer 300 carries out various functions in accordance with routines stored in an associated memory circuitry 302. The associated memory circuitry 302 may also store configuration parameters, imaging protocols, operational logs, raw and/or processed operational information received from the sensors, and so forth.

The controller 30 may further include interface circuitry 304, also referred to herein as a front end, that is configured to received the inputs from the various sensors described herein. The interface circuitry 304 may include an analog-to-digital converter (not shown) that converts the analog signals received from the sensors to digital signals that may be utilized by the computer 300. The interface circuitry 304 may also include signal conditioning capabilities for operating the various sensors.

The controller 30 may be coupled to a range of external devices via a communications interface. Such devices may include, for example, an operator workstation 306 for interacting with the controller 30. The operator workstation 306 may be embodied as a personal computer (PC) that is positioned near the controller 30 and hard-wired to the controller 30 via a communication link 308. The workstation 306 may also be embodied as a portable computer such as a laptop computer or a hand-held computer that transmits information to the system controller 30. In one embodiment, the communication link 308 may be hardwired between the controller 30 and the workstation 306. Optionally, the communication link 308 may be a wireless communication link that enables information to be transmitted to or from the controller 30 to the workstation 306 wirelessly. In the exemplary embodiment, the workstation 306 is configured to receive information from the controller 30 in real-time operation to enable a remote operator to monitor the performance of the gearbox 32.

The workstation 306 may include a central processing unit (CPU) or computer 310. In operation, the computer 310 executes a set of instructions that are stored in one or more tangible and non-transitory storage elements or memories, in order to process input data received from the controller 30. The storage elements may also store data or other information as desired or needed. The storage elements may be in the form of an information source or a physical memory element within the computer 310. The set of instructions may include various commands that instruct the computer 310 to perform various gearbox monitoring functions. The controller 30 and/or the computer 310 may be programmed to identify performance deficiencies within the gearbox 32. For example, the computer 310 may be programmed to received the various sensor inputs generated by the sensors described above. The computer 310 may be further programmed to compare the sensors inputs to various design parameters stored n the computer 310. Based on the comparison, the computer 310 may generate an output that represents a significant variation between the actual operational characteristics of the gearbox 32 and the expected or operational characteristics as determined based on the design information. Based on the information output from the various sensors, in some embodiments, the controller 30 or the computer 310 may automatically stop the operation of the wind turbine 10 when the health or performance information indicates that a component within the gearbox 32 is damaged or may have potential damage.

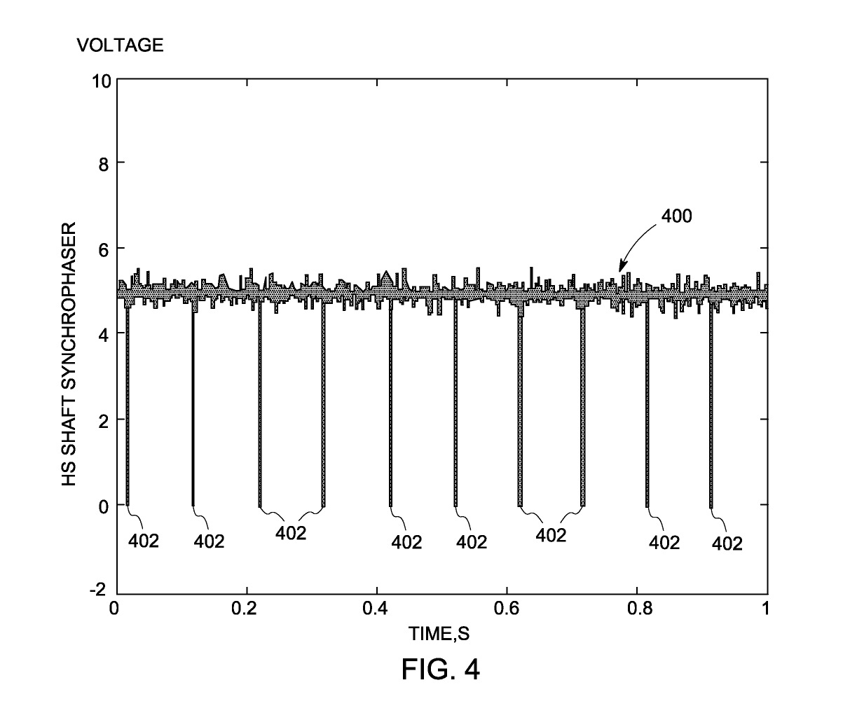

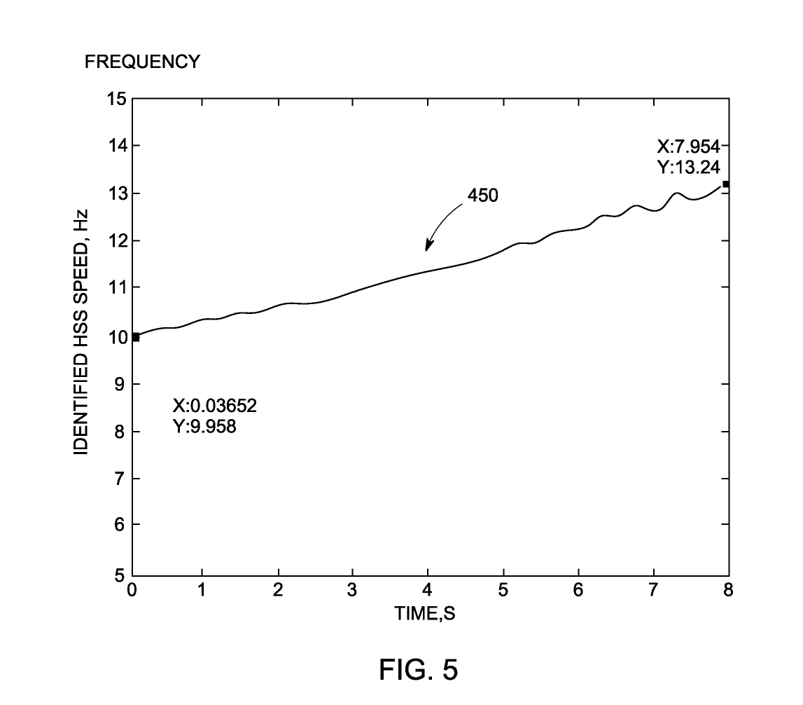

For example, FIG. 4 is a graphical illustration of exemplary information acquired using the second tachometer 202 that is installed proximate to the high-speed shaft 174 where the X-axis represents time and the Y-axis represents the voltage output from the second tachometer 202. In operation, the tachometer 202 generates a signal 400 that represents the rotational speed of the high speed shaft 174. As shown in FIG. 4, each time a target (not shown), installed on the high speed shaft 174, passes the tachometer 202, a pulse 402 is generated. In the exemplary embodiment, the graph illustrates a plurality of pulses 402 and the time between each pulse indicating one whole rotation of the high speed shaft 174. In the exemplary embodiment, the raw data received from the tachometer 202 is utilized by the controller 30 to generate the high-speed shaft rotational speed information shown in FIG. 5. The shaft speed information is further utilized in sensor signal processing to improve damage feature extraction by eliminating the variable shaft speed effects. It should be realized that although only a single tachometer graph is illustrated, the controller 30 may generate a graph for some or all of the tachometers described above.

FIG. 5 is a graphical illustration of the raw data shown in FIG. 4 that has been converted to a shaft speed graph 450 using the controller 30. As discussed above, FIG. 4 represents the raw tachometer data received from the tachometer 202 mounted to the high speed shaft 174. Whereas, FIG. 5 represents actual rotational speed of the shaft 174 over time. In the exemplary embodiment, the raw signal 400 shown in FIG. 4 is converted to the shaft speed graph 450 shown in FIG. 5 using the controller 30. Specifically, FIG. 5 represents the high-speed shaft rotational speed during a speed up process after being digitized by the controller 30. As shown in FIG. 5, as the speed of the wind turbine 10 increases, the rotational speed of the high-speed shaft 174 increases from approximately 9.96 Hz to approximately 13.24 Hz in 8 seconds. Though the high-speed shaft 174 speed change is relatively small, because the gearmeshing frequency and bearing frequencies are multiples (not necessarily an integer order) of the high-speed shaft 174 speed, the variations at the gearmeshing frequency and bearing frequencies is amplified. Specifically, as shown in FIG. 5, the rotational speed of the high-speed shaft 174 varies based on the wind speed and other factors. In the exemplary embodiment, the graph shown in FIG. 5 is generated by the controller 30 and used by the signal processor to get accurate health condition features in processing the sensor data obtained by the front-end

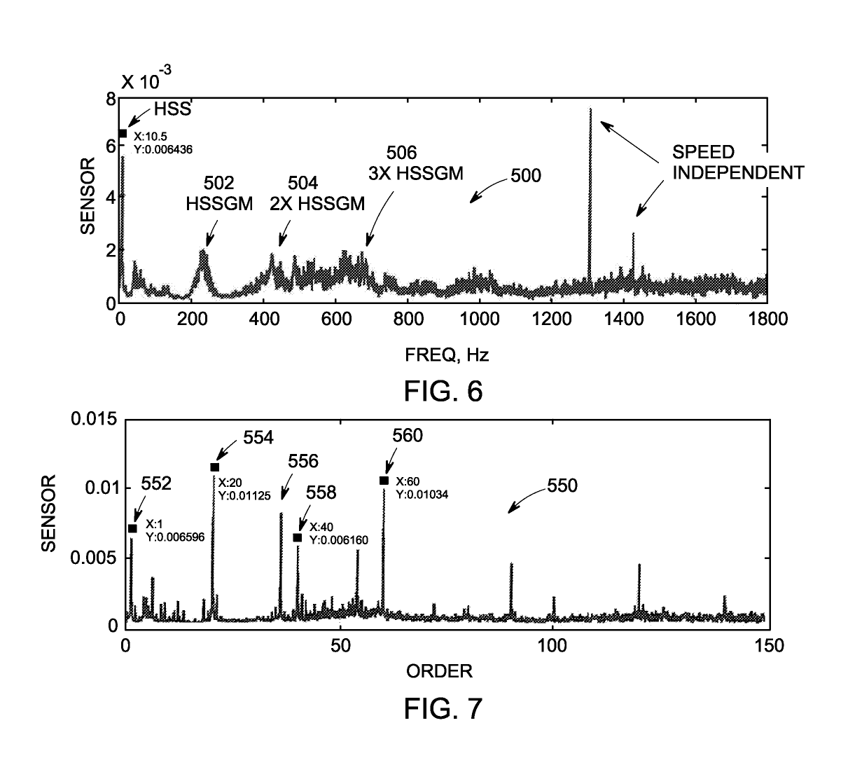

FIG. 6 is a graphical illustration of an exemplary signal 500 generated using information received from the accelerometer 256 that is mounted proximate to the a high-speed gear set 114 where the X-axis represents frequency and the Y-axis represents the voltage output from the accelerometer 256.

More specifically, during operation, as the teeth (not shown) in the gears of the high-speed gear set 114 mesh, at least some vibration occurs. This vibration is observed by the accelerometer 256 and transmitted to the controller 30 for processing. In one exemplary embodiment, the controller 30 applies a Fast-Fourier Transform (FFT) to the raw data received from the accelerometer 256 to generate the line 500 shown in FIG. 6. As shown in FIG. 6, a plurality of High Speed Gear-Meshing (HSSGM) locations are represented. For example, HSSGM 502 represents the fundamental gearmeshing frequency extracted from the signal acquired from the accelerometer 256. Whereas, HSSGM 504 and HSSGM 506 are high order harmonics of the fundamental HSSGM 502. Due to the speed variations, the FFT based analysis method may not adequately enable an operator to identify this gearmeshing frequency and amplitude, which contains gear tooth health conditions. This deficiency is further amplified in higher frequencies. For example, it is difficult to distinguish the second harmonic of the HSSGM 504 and the third harmonics of the HSSGM 506.

As shown in FIG. 6, the signal HSS represents the averaged speed of the high-speed shaft 174. During operation, the signal 500 indicates that the high-speed shaft frequency is approximately 10.5 Hz under the frequency resolution of 0.5 Hz.

FIG. 7 is a graphical illustration of advanced signal processing results 550 generated using the same information received from the accelerometer 256 as is used to generate the line 500 shown in FIG. 6. As shown in FIG. 7, the X-axis represents order domain of the signal 500 shown in FIG. 6 and the Y-axis represents the acceleration (in g) output from the accelerometer 256. More specifically, the signals that are blurred humps in the frequency domain shown in FIG. 6, appear as distinguished peaks 552-560 in the order domain shown in FIG. 7. In the exemplary embodiment, point 552 represents the rotational speed of the high speed shaft 174. Moreover, point 554 corresponds to the gearmeshing order, while points 558, 560, etc., represent higher orders of the gearmeshing order 554. In this example, the high-speed gear pinion 174 has twenty teeth, thus the high speed gearmeshing order 554 is 20, which means 20 times meshing happened in one revolution of the high speed shaft. In the exemplary embodiment, the controller 30 applies the speed variation information generated in 450 to the raw data received from the accelerometer 256 to generate the line 550 shown in FIG. 7. Using the exemplary filter, the sidebands around each point 554, 556, 558, 560, etc. are also easily distinguished enabling an operator or design engineer to identify the sidebands around each peak, which contain the gear teeth health information. This information may then be utilized by the operator to monitor the health condition of the gearbox 32. As shown in FIG. 7, the variation due to the shaft speed change has been eliminated. Because the order analysis shown in FIG. 7 is based on the high-speed shaft 174, the order of the high-speed shaft 174 is exactly at 1 and the high-speed gearmeshing fundamental order is at 20 in this exemplary configuration. Furthermore, the higher orders of the high-speed gearmeshing frequencies are also clearly identifiable.

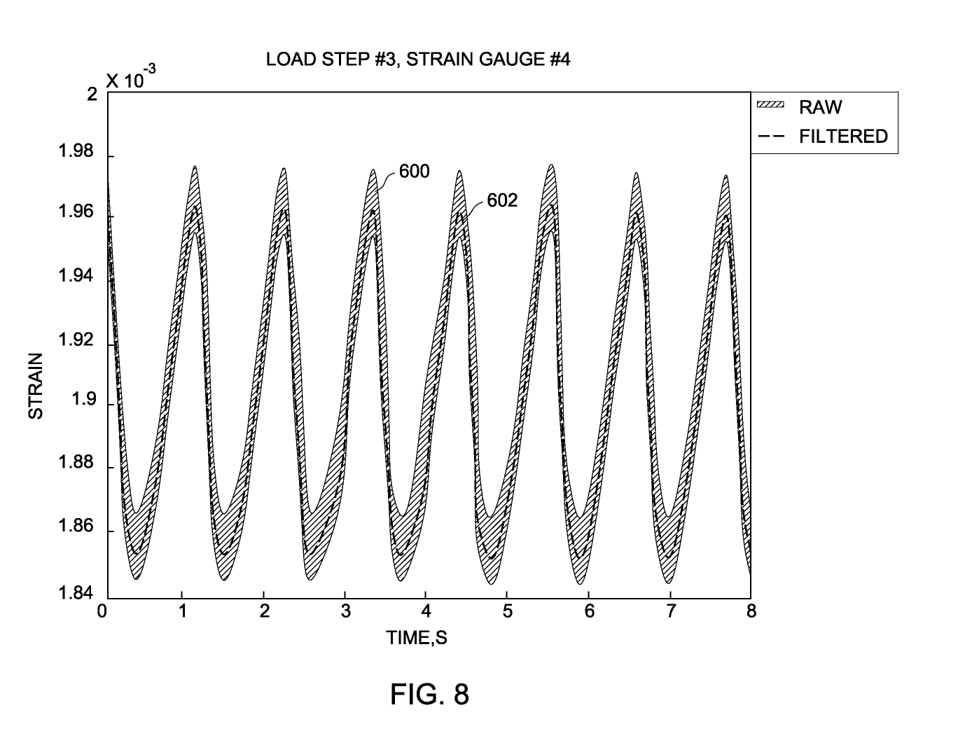

FIG. 8 is a graphical illustration of exemplary information received from the first strain gauge 210 that is mounted proximate to the torque arm 46 where the X-axis represents time and the Y-axis represents the strain during normal operation. As shown in FIG. 8, the line 600 represents the raw data acquired from the strain gauge 210 and the line 602 represents the filtered data. A wavelet transform based filter technique is used to effectively filter out the very low frequency component in the sensor signal.

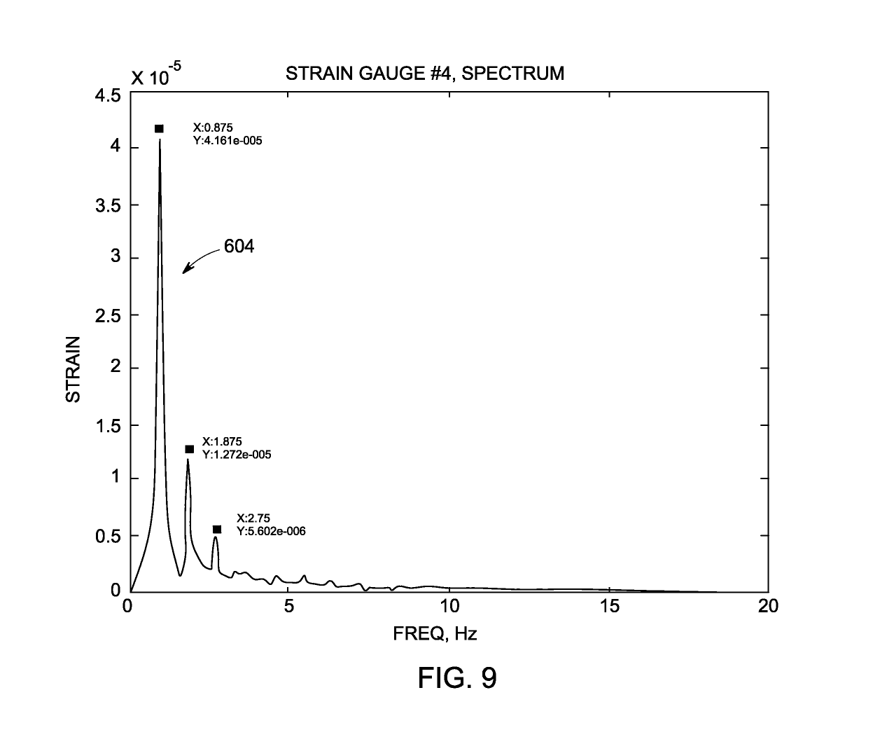

FIG. 9 is a graphical illustration of exemplary information shown in FIG. 8 after processing the strain information using a FFT. In the exemplary embodiment, the controller 30 applies the FFT to the filtered data 602 shown in FIG. 8 to produce the line 604 shown in FIG. 9. As shown in FIG. 9, the strain data is utilized to determine the strain at this location due to the planetary gear 120 rotating through the ring gear 140. The strain gauge response shown in FIG. 9 can be used to determine the stress when the planetary gear meshes with the ring gear. Moreover, the determined stress may be compared to a predetermined stress to determine whether the gearbox 32 is operating within design parameters. It should be realized that similar information may be acquired for other gears within the gearbox 32 using the other strain gauges described above.

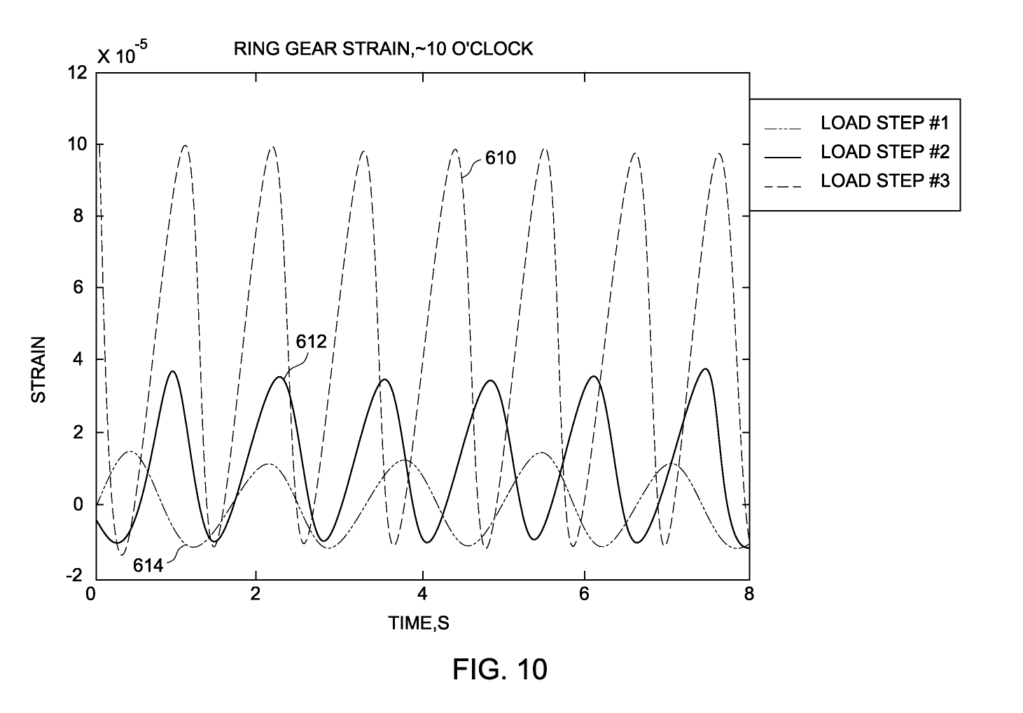

FIG. 10 is a graphical illustration of exemplary information received from the first strain gauge 210 that is mounted proximate to the torque arm 46 where the X-axis represents time and the Y-axis represents the strain during normal operation. As shown in FIG. 10, the line 610 represents the raw data acquired from the strain gauge 210 under a first loading condition. Line 612 represents the raw data acquired from the strain gauge 210 under a second loading condition. Line 614 represents the raw data acquired from the strain gauge 210 under a third loading condition.

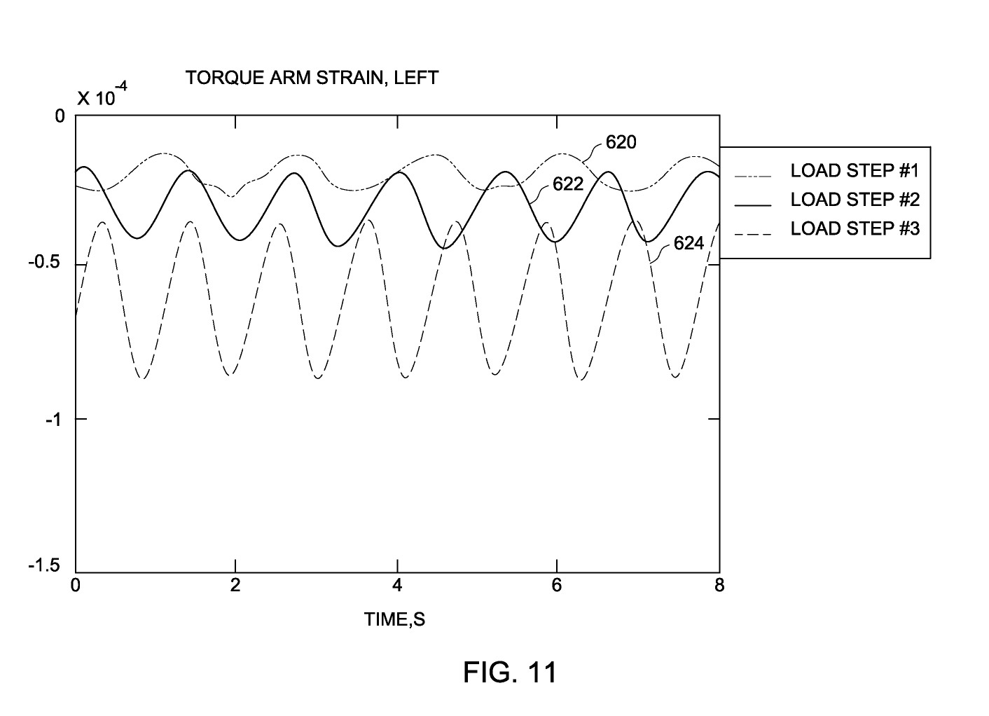

FIG. 11 is a graphical illustration of exemplary information received from the second strain gauge 212 that is mounted proximate to the torque arm 46. The line 620 represents the raw data acquired from the strain gauge 212 under a first loading condition. Line 622 represents the raw data acquired from the strain gauge 212 under a second loading condition. Line 624 represents the raw data acquired from the strain gauge 212 under a third loading condition.

A technical effect of the various embodiments is to provide a system that is configured to monitor both the performance of a wind turbine gearbox and also to determine the health of the wind turbine gearbox. The system includes various sensors that are coupled to the gearbox. The outputs from the various sensors are input to a controller. Information obtained from various sensors installed in the gearbox may be transmitted to the controller via a wired or wireless connection. Digitized sensor signals are then processed by the controller to extract bearing component health conditions and to assess gearbox performance. The information may also be transmitted to gearbox customers and engineers through a wired or wireless communication devices. Additionally, operators and designers may request actions needed through the communication device and the controller.

In operation, the controller is configured to utilize the sensor information to output information that enables an operator to monitor the performance of the wind turbine. Additionally, the controller is configured to output information that enables a designer to monitor the design of the wind turbine. Specifically, the operator may compare the sensor outputs to a predetermined set of outputs to determine whether the gearbox is operating within operational guidelines. Optionally, the controller may be programmed to compare the sensor outputs to the predetermined set of outputs and then generate an audio or visual indication when a sensor output exceeds a predetermined threshold or is not operating within operational guidelines. Additionally, the designer may use the same or different outputs to determine whether the gearbox is operating within design limitations. The designer may also utilize the sensor outputs to modify the wind turbine gearbox to improve the overall efficiency of the wind turbine. In various embodiments, the system is also configured to estimate various parameters that are not directly obtained from a respective sensor.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. For example, the ordering of steps recited in a method need not be performed in a particular order unless explicitly stated or implicitly required (e.g., one step requires the results or a product of a previous step to be available). While the dimensions and types of materials described herein are intended to define the parameters of the invention, they are by no means limiting and are exemplary embodiments. Many other embodiments will be apparent to those of skill in the art upon reviewing and understanding the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose various embodiments of the invention, including the best mode, and also to enable any person skilled in the art to practice the various embodiments, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system comprising:
a plurality of sensors coupled to a wind turbine gearbox; and
a controller coupled to the plurality of sensors and generating health and performance information of the wind turbine gearbox based on information received from the plurality of sensors.

2. The system in accordance with claim 1, wherein the plurality of sensors comprises at least two sensors from a tachometer, a strain gauge, a temperature sensor, a proximity probe, and an oil particle counter.

3. The system in accordance with claim 1, wherein the controller is configured to wirelessly transmit the information received from the plurality of sensors to a remote workstation.

4. The system in accordance with claim 3, wherein the remote workstation generates a graphical illustration to enable a designer to determine if the wind turbine gearbox is operating within design parameters.

5. The system in accordance with claim 1, wherein the controller is configured to generate a visual or audio output when at least one of the sensors indicates that the wind turbine gearbox is not operating within predetermined parameters.

6. The monitoring system in accordance with claim 1, wherein the controller is configured to generate health information representing a damaged component within the wind turbine gearbox based on the information received from the plurality of sensors.

7. The system in accordance with claim 1, wherein the controller is configured to generate health information representing a damaged gear and/or bearing within the wind turbine gearbox based on information received from an accelerometer.

8. The system in accordance with claim 1, wherein the plurality of sensors comprises a plurality of proximity probes coupled to a gearbox torque arm, the plurality of proximity probes outputting information representing the motion of the gearbox torque arm in three axes.

9. The system in accordance with claim 1, wherein the plurality of sensors comprises a plurality of strain gauges coupled to a gearbox torque arm, the plurality of strain gauges outputting information representing the stress status of the gearbox torque arm.

10. The system in accordance with claim 1, wherein the plurality of sensors comprises a plurality of oil particle counters coupled to a gearbox lubrication system, the plurality of oil particle counters outputting information representing the health condition of the gearbox lubrication system.

11. The system in accordance with claim 1, wherein the plurality of sensors comprises at least one strain gauge mounted proximate to a ring gear set, the controller configured to determine the performance and health of the ring gear set based on information received from the strain gauge.

12. A wind turbine comprising:
a rotor including a plurality of blades;
a gearbox coupled to the rotor;
a generator coupled to the gearbox;
a plurality of sensors coupled to the gearbox; and
a controller coupled to the plurality of sensors and generating health and performance information of the gearbox based on information received from the plurality of sensors.

13. The wind turbine in accordance with claim 12, wherein the monitoring system comprises a tachometer, a strain gauge, a temperature sensor, a proximity probe, and an oil particle counter.

14. The wind turbine in accordance with claim 12 wherein the controller is configured to wirelessly transmit information received from the plurality of sensors to a remote workstation.

15. The wind turbine in accordance with claim 12 wherein the controller is configured to transmit information received from the plurality of sensors to a remote workstation, the remote workstation generating a graphical illustration to enable a designer to determine if the gearbox is operating within design parameters.

16. The wind turbine in accordance with claim 12 wherein the controller is configured to generate a visual or audio output when at least one of the sensors indicate the gearbox is not operating within predetermined guidelines.

17. The wind turbine in accordance with claim 12 wherein the controller is configured to generate health information representing a damaged component within the gearbox based on the information received from the plurality of sensors.

18. The wind turbine in accordance with claim 12 wherein the controller is configured to generate health information representing a damaged gear within the gearbox based on an information received from a strain gauge.

19. The wind turbine in accordance with claim 12 wherein the plurality of sensors includes a plurality of proximity probes coupled to a gearbox torque arm, the plurality of proximity probes outputting information representing the motion of the torque arm in three axes.

20. The wind turbine in accordance with claim 12 wherein the plurality of sensors comprises a plurality of oil particle counters coupled to a gearbox lubrication system, the plurality of oil particle counters outputting information representing the health condition of the gearbox system.

21. A method of monitoring the health and performance of a wind turbine gearbox comprising:
receiving operation information from a plurality of sensors coupled to the wind turbine gearbox; and
generating, using a processor, health and performance information for the wind turbine gearbox based on the operation information received from the plurality of sensors; the controller being configured to receive information from the plurality of sensors, and based on the received information, generate output information that includes performance and health information of the wind turbine gearbox.

22. The method in accordance with claim 21, wherein receiving operation information comprises receiving information from at least two sensors from sensors including a tachometer, a strain gauge, a temperature sensor, and a proximity probe to the gearbox.

23. The method in accordance with claim 21, further comprising wirelessly transmitting the operation information received from the plurality of sensors to a remote workstation.
